(19) United States
(12) Patent Application Publication
(10) Pub. No.: US 2012/0182399 A1
(43) Pub. Date: Jul. 19, 2012

(54) METHOD AND AN ARRANGEMENT FOR ESTIMATING 3D MODELS IN A STREET ENVIRONMENT

(75) Inventors: Ingmar Andersson, Linkoeping (SE); Folke Isaksson, Linkoping (SE); Leif Haglund, Brokind (SE); Johan Borg, Linkoping (SE); Johan Bejeryd, Linkoping (SE)

(73) Assignee: SAAB AB, Linkoeping (SE)

(21) Appl. No.: 13/381,840

(22) PCT Filed: Jun. 30, 2009
(86) PCT No.: PCT/SE09/00340

§ 371 Date: Mar. 22, 2012

(51) Int. Cl. H04N 13/02

(52) U.S. Cl. 348/47; 348/E13.074; 348/E13.014

(57) ABSTRACT

A method and arrangement for estimating 3D-models in a street environment using a stereo sensor technique. At least one pair of sensors are arranged in pairs and are mounted on a bracket. Each pair of sensors is positioned in a common plane. The sensors of each pair are positioned based upon contrast information such that low levels of contrasts in an image plane are avoided. The pairs of sensors are mutually positioned relative to an essentially horizontal plane of the bracket such that the sensors of a sensor pair are positioned horizontally at a distance from each other and one of the sensors above the horizontal plane of the bracket and the other under the horizontal plane.

The present invention relates to a method for estimating 3D-models in a street environment using stereo sensor technique, the sensors comprised being arranged in pairs. The invention also refers an arrangement for estimating 3D-models in a street environment using stereo sensor technique, comprising at least one pair of sensors mounted on a bracket, each pair of sensors being positioned in a common plane.

To estimate a 3D model from stereo photogrammetric methods is a known problem for manual utilizing of stereo goggles which also has been solved utilizing computers. For background information it can be referred to PCT/EP2007/056780 and EP patent application 07445047.9. Classically the results are based upon images taken from different positions covering the same scene in the world.

Other examples of sensor pair arrangements are per se known from US 20040105579 A1 and JP8278126 A, both disclosing cameras in pairs having one camera positioned above the other.

However, there still exist problems under certain conditions. One problem is that it is impossible to measure the stereo effect towards quite homogeneous surfaces. It is also impossible to measure the stereo effect if contrasts in the image only exist perpendicular in the image plane relative to the movement of the sensors.

The object of the invention is to propose a solution to the problems to measure the stereo effect under the above indicated conditions. The idea is to locate the positions of the sensors of a stereo sensor pair at the imaging moment in a mutual relation such that there is an increase of contrasts in the image plane.

The object of the invention is solved by a method characterized in that the sensors of each pair comprised, are positioned based upon contrast information such that low levels of contrasts in an image plane are avoided and an arrangement characterized in that comprised pairs of sensors are mutually positioned relative to an essentially horizontal plane of the bracket such that the sensors of a sensor pair is positioned horizontally at a distance from each other and one of the sensors above the horizontal plane of the bracket and the other under the horizontal plane. The solution is to increase or maximise the contrasts appearing in the image plane at the imaging instant by the mutual positioning of the sensors of a sensor pair.

According to a preferred method a priori knowledge about the presence of the spatial direction of the contrasts are used to increase the levels of contrasts in the image plane. An a priori knowledge in street environment is that most of the contrasts are either vertical or horizontal. Examples of such contrasts are signposts, doors and windows. Based upon such a priori knowledge it is according to a preferred method proposed that the sensors of a sensor pair in a street environment are positioned at different levels in a common vertical plane and according to still another preferred method that the sensors are positioned such in the common vertical plane that an imaginary line between the sensors of a pair is inclined between 30 and 60 degrees relative to a horizontal plane and preferably about 45 degrees. For the contrast examples given above an inclination of 45 degrees are ideally preferred.

According to yet another preferred method the sensors are positioned based upon a contrast analyse of available or preceding images.

The sensor arrangement is characterized in that comprised pairs of sensors are mutually positioned relative to an essentially horizontal plane of the bracket such that the sensors of a sensor pair is positioned horizontally at a distance from each other and one of the sensors above the horizontal plane of the bracket and the other under the horizontal plane.

Preferably the sensors of a pair are positioned relative to the horizontal plane of the bracket such that an imaginary line between the sensors of a pair is inclined between 30 and 60 degrees relative to the horizontal plane and preferably about 45 degrees.

According to a favourable embodiment of the arrangement at least two pairs of sensors and preferably three pairs are mounted on the horizontal plane of the bracket evenly distributed to cover 360 degrees in the horizontal plane. By the introduction of at least two and preferably three stereo pairs it is possible to cover the surrounding all around.

According to another favourable embodiment of the arrangement the bracket is provided with at least a stereo sensor pair directed to look upwards. Such an arrangement enables formation of a still more complete 3D image.

Preferably the arrangement for estimating 3D models is mounted on a vehicle such as a car. To facilitate the mounting on a vehicle the bracket of the arrangement is provided with mounting elements to be fixt on the vehicle.

The invention will now be described in more detail with reference to the accompanying drawings in which:

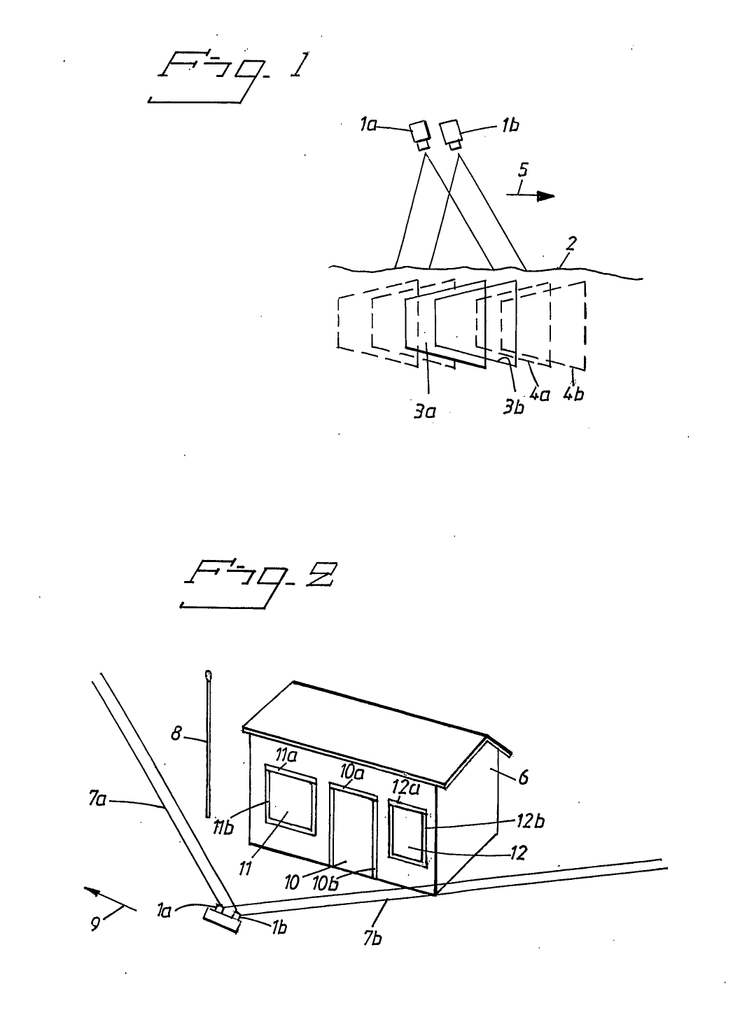

FIG. 1 schematically illustrates stereo recording.

FIG. 2 schematically illustrates stereo recording in a street environment.

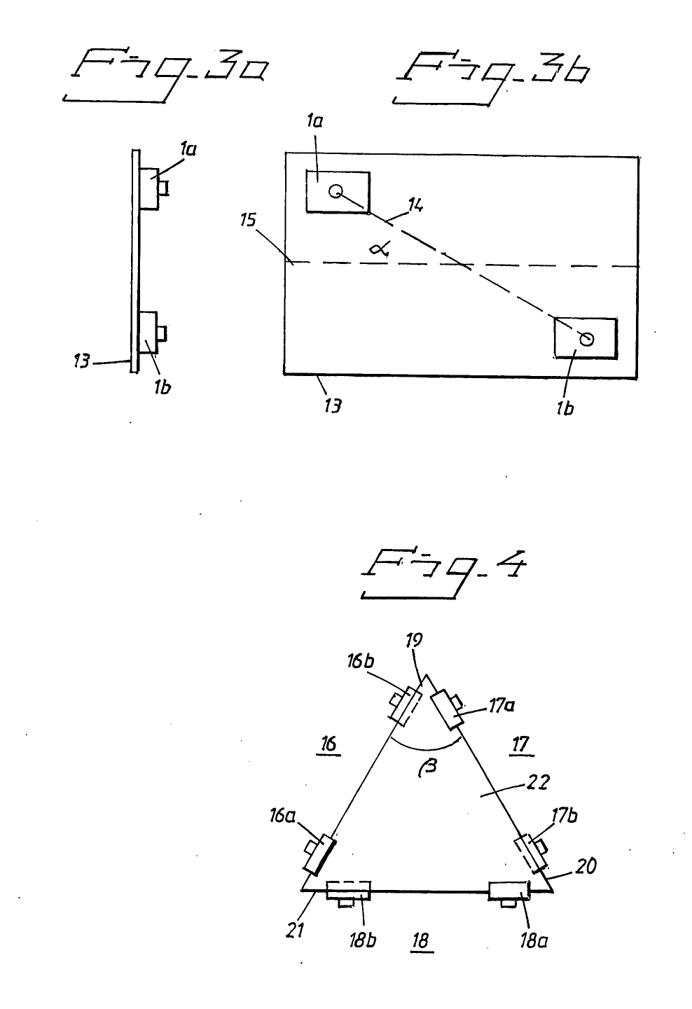

FIG. 3a schematically shows a vertical side view of a sensor arrangement in accordance with the invention.

FIG. 3b schematically shows a vertical front view of the sensor arrangement according to FIG. 3a.

FIG. 4 schematically shows a top view of a sensor arrangement in accordance with the invention provided with three stereo sensor pairs.

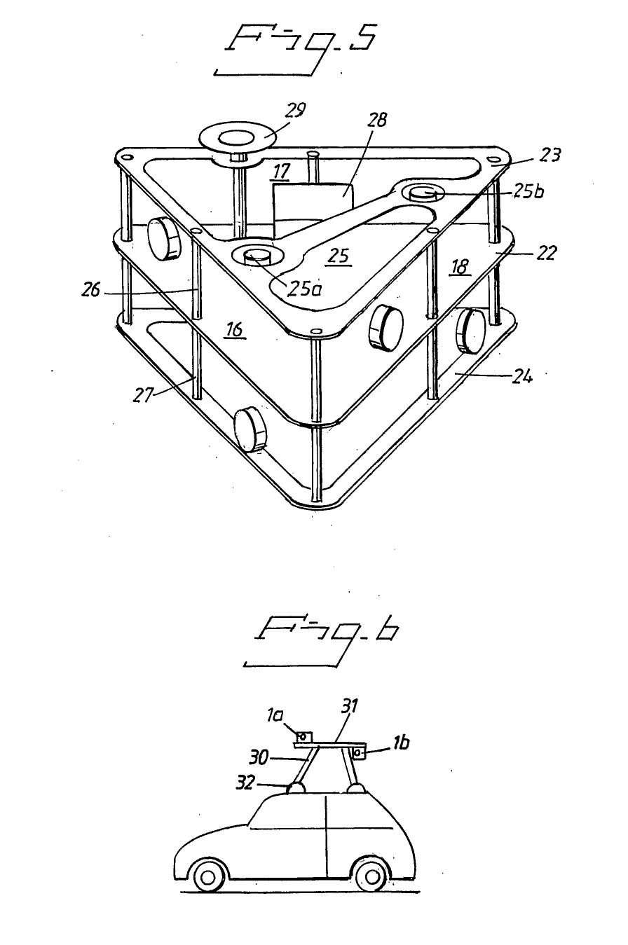

FIG. 5 shows a schematic perspective view of still another sensor arrangement with three stereo sensor pairs mounted in a bracket in accordance with the invention.

FIG. 6 shows a vehicle provided with pairs of stereo sensors in accordance with the invention mounted on a bracket on the roof of the vehicle.

In FIG. 1 a known principle of stereo recording of an area 2 is illustrated. A mutually fixed mounted sensor pair 1a and 1b is comprised and directed to record or image the area 2 such as the façades of houses. At the sensor position shown, sensor 1a senses an area 3a while sensor 1b senses an area 3b. By moving the sensor pair 1a, 1b in the direction shown by arrow 5, the areas 4a and 4b are sensed a bit later. Moving and sensing the area 2 in this way results in that a plurality of at least partly overlapping images are generated to be used as a base for thee dimensional image displaying.

According to FIG. 2 a sensor pair 1a, 1b is illustrated to capture images in front of a house 6. The sensors are here positioned in a plane essentially parallel to the façade of the house. The covering field of the sensors are denoted by 7a for sensor 1a and with 7b for sensor 1b. In addition to the house 6 a flagpole 8 is shown. If the sensors are mounted at the same level relative to ground and moved parallel with the ground perpendicular to the house façade there are no contrasts to identify along for example longitudinal linings 10a, 11a, 12a above the door 10 or the windows 11, 12. An arrow 9 indicates such a moving direction. On the contrary if the sensors are arranged above each other and are moved upwards or downwards to capture an image of the house and its surroundings, contrasts will be lacking in vertical linings of windows 11b, 12b and of the door 10b as well as along the vertical flagpole 8.

Examples of solutions to overcome the problems with lack of contrasts will now be described with reference to FIGS. 3a, 3b, FIG. 4, and FIG. 5.

According to FIGS. 3a and 3b a sensor arrangement with one stereo sensor pair is shown. The sensors 1a and 1b are positioned in a vertical plane 13 as illustrated so that one of the sensors 1a is positioned at a higher level than the other sensor 1b. The vertical plane may be a real plane but could also be an imaginary plane. In the last case the sensors are mounted in any kind of bracket or holder. FIG. 3a shows the arrangement in a vertical side view while FIG. 3b shows the arrangement in a vertical front view. In FIG. 3b there is shown a broken line 14 connecting the centre of sensor 1a with the centre of sensor 1b. This line is inclined an angle α relative to the ground plane and a broken line 15 parallel to the ground plane. In order to avoid the contrast problems with vertical and horizontal sections with low contrasts it is proposed that the angle α lies between 30 and 60 degrees and preferably around 45 degrees. Examples of suitable sensors are cameras.

FIG. 4 schematically shows an arrangement for estimating 3D models in a top view. The arrangement comprises three pairs of sensors 16, 17 and 18. Each pair of sensors is positioned in en essential vertical plane 19, 20 and 21 respectively. These three planes are arranged so that there is an angle β in the horizontal plane between the planes of 60 degrees. The sensor pair 16 comprises a first sensor 16a and a second sensor 16b. In a corresponding way the sensor pair 17 comprises a first sensor 17a and a second sensor 17b, and the sensor pair 18 comprises a first sensor 18a and a second sensor 18b. In each sensor pair the first sensor 16a, 17a and 18a are arranged at a higher level than each second sensor 16b, 17b, and 18b. In this shown example the sensors are mounted on a mounting plate 22 so that each first sensor 16a, 17a and 18a, respectively, is located above the plate while each second sensor 16b, 17b and 18b, respectively, is located underneath the plate 22.

Another example of an arrangement comprising three pairs of sensors in vertical planes is shown in a perspective view in FIG. 5. This construction is built up of three parallel mounting plates 22, 23 and 24 housing the sensors and separated by pins 26, 27 connecting the mounting plates 22, 23 and 24 together. In addition to the three sensor pairs 16, 17 and 18 similar to the arrangement of FIG. 4, the arrangement comprises another sensor pair 25 located at the top of the arrangement to cover an area upwards. The sensors are denoted 25a and 25b. The sensors are only indicated as an object lens of a camera leaving out the arrangement of the camera behind. It could also be noted that the lower positioned sensor of the sensor pair 17 is hided by the mounting plate 22 and thus not visible in FIG. 5. Information from the sensors is collected in an electronic unit 28 together with position information received from a GPS provided with an antenna 29.

In FIG. 6 an arrangement with sensor pairs is shown mounted on the roof a vehicle. Legs 30 from the bracket 31 holding the sensors are connected to load carriers 32 connected to the vehicle. In this case just one sensor pair comprising an upper sensor 1a and a lower sensor 1b is shown, but three or more sensors pairs could be used in a preferred embodiment.

The invention is not limited to the examples described above but may be modified within the scope of the attached claims.

1. A method for estimating 3D-models in a street environment using a stereo sensor technique, the sensors comprised being arranged in pairs, the method comprising:
positioning the sensors of each pair based upon contrast information such that low levels of contrasts in an image plane are avoided by positioning the sensors of a sensor pair at different levels in a common vertical plane and horizontally at a distance from each other.

2. The method according to claim 1, wherein a priori knowledge about a presence of a spatial direction of the contrasts are used to increase the levels of contrasts in the image plane.

3. The method according to claim 1, wherein the sensors are positioned in the common vertical plane so that an imaginary line between the sensors of a pair is inclined between 30 and 60 degrees relative to a horizontal plane.

4. The method according to claim 1, wherein the sensors are positioned based upon a contrast analysis of available or preceding images.

5. An arrangement for estimating 3D-models in a street environment using a stereo sensor technique, the arrangement comprising:
at least one pair of sensors mounted on a bracket, each pair of sensors being positioned in a common plane, wherein the pairs of sensors are mutually positioned relative to an essentially horizontal plane of the bracket such that the sensors of a sensor pair are positioned horizontally at a distance from each other and one of the sensors above the horizontal plane of the bracket and the other under the horizontal plane.

6. The arrangement according to claim 5, wherein the sensors of a pair are positioned relative to the horizontal plane of the bracket such that an imaginary line between the sensors of a pair is inclined between 30 and 60 degrees relative to the horizontal plane.

7. The arrangement according to claim 5, wherein at least two pairs of sensors are mounted on the horizontal plane of the bracket evenly distributed to cover 360 degrees in the horizontal plane.

8. The arrangement according to claim 7, wherein three pairs are mounted on the horizontal plane of the bracket.

9. The arrangement according to claim 5, wherein the bracket comprises at least a stereo sensor pair directed to look upwards.

10. The arrangement according to claim 5, wherein the bracket comprises mounting elements to be fixed on a vehicle.

11. The method according to claim 3, wherein the imaginary line between the sensors of a pair is inclined about 45 degrees.

12. The arrangement according to claim 6, wherein the imaginary line between the sensors of a pair is inclined about 45 degrees.
